(19) United States
(12) Patent Application Publication
(10) Pub. No.: US 2002/0157425 A1
(43) Pub. Date: Oct. 31, 2002

(54) Method for producing a quartz glass body

(76) Inventors: Jorg Werner, Budingen (DE); Clemens Schmitt, Blankenbach (DE); Gerhard Kotulla, Hanau (DE); Wolfgang Krock, Erlensee (DE)

Correspondence Address: LAW OFFICE OF ANDREW L. TIAJOLOFF, C/O ROBIN BLECKER & DALEY, 330 MADISON AVENUE, NEW YORK, NY, 10017, US

(21) Appl. No.: 09/979,403

(22) PCT Filed: Mar. 9, 2001
(86) PCT No.: PCT/EP01/02651

(30) Foreign Application Priority Data
Mar. 14, 2000 (DE) 100 12 227.2

(51) Int. Cl. C03B 37/018

(52) U.S. Cl. 65/421

(57) ABSTRACT

The invention relates to a procedure for manufacture of a quartz glass body by deposition of SiO₂ particles on the outer surface of a cylindrical mandrel rotating around its longitudinal axis under formation of an essentially cylindrical porous blank with an inside bore hole, and by removing the mandrel and sintering of the blank, characterized in that the mandrel in the area of one of the ends of the successively forming blank is surrounded by a shaping element rotating at the same rotation velocity as the mandrel, such shaping element having a core area facing the blank which is at least partially removably embedded into the front face of the successively forming blank and which is removed before sintering after having widened the inside bore hole of the blank with a shape complementary to that of the core area.

The present invention relates to a procedure for the manufacture of a quartz glass body by depositing SiO₂ particles onto the cylindrical outer surface of a mandrel rotating around its longitudinal axis thereby forming an essentially cylindrical porous blank with an inside bore hole, and by removing the mandrel and sintering of the blank.

The quartz glass body is characterized by being a hollow cylinder or a rod made of synthetic glass, or a preform for optical glass fiber production. Quartz glass hollow cylinders are used as intermediate products in numerous component parts of the optical and chemical industries. Commonly, quartz glass hollow cylinders are manufactured by depositing SiO₂ particles onto an elongated, rod- or tube-shaped carrier (mandrel) forming a porous, hollow cylinder-shaped blank (soot body), which is sintered in the final step of manufacture. The carrier is removed prior to or after sintering. To fabricate a rod or preform from the blank, the bore hole of the blank is made to collapse during the sintering process or in a separate step of the procedure. The porous blank or sintered hollow cylinder can also be made to collapse onto a pre-made rod. Commonly, the bore hole needs to be processed prior to collapsing in order to clean and/or smooth the internal surface. A known procedure for the introduction of a treatment gas into the bore hole has holder elements embedded at the ends and a so-called tube pipe welded to the blank.

A method for the manufacture of quartz glass bodies of the type described above is known from DE-A1 197 51 919. In this method, a flame hydrolysis burner is used to deposit layers of SiO₂ particles onto the surface of a slightly conical mandrel clamped at both its ends into a lathe and rotating around its longitudinal axis, producing in the process through back and forth motions along the longitudinal axis of the mandrel a longitudinal porous blank of SiO₂ particles.

For holding and handling the porous blank in the process steps following the deposition of SiO₂ particles, quartz glass holder elements are integrated into the ends of the blank. For this purpose, the mandrel extends through bushing-shaped holders which become partially embedded in the successively forming blank during the deposition step. To provide for a stable and firm connection between the blank and the two holders, the areas adjacent to the ends of the blank are heated with additional burners, thus effectively compacting the blank. Once deposition is complete, the mandrel is removed and the blank sintered and collapsed. The blank can be held by the holder elements either suspended in vertical direction or supported in horizontal direction during these processing steps.

The manufacture of holder elements for both ends in accordance with the known method is relatively work- and cost-intensive. Frequently, it is easier not to use an embedded holder element, but to weld onto the end a so-called tube pipe made of quartz glass through which a processing gas can be fed to the inside bore hole. To weld the tube pipe onto the end, it is only necessary to heat the respective end of the blank and soften the quartz glass. However, as the quartz glass softens the inside of the bore hole may close, especially if the internal diameter is rather small, which renders the inside bore hole nearly impossible to rework, such that the blank must be discarded.

The invention relates to the task of modifying the known method for manufacture of a quartz glass body such that a tube pipe can be easily welded to the ends of the blank.

This task is solved in the invention on the basis of the afore-mentioned procedure by surrounding the mandrel at one end of the successively forming blank with a shaping element rotating at the same speed as the mandrel, this shaping element being designed to have a core facing the blank of which that becomes at least partially embedded into the end of the successively forming blank in the form of a detachable connection. When the shaping element is removed prior to the sintering step, it will effectively have widened the inside bore hole to match the core of the shaping element.

In the procedure of the invention, the inside bore hole of the blank becomes widened at the end such that the risk of the quartz glass closing while the inside bore hole is heated and softened is reduced, which simplifies the attachment of the tube pipe at the respective end of the blank.

The blank is widened at its end by means of a shaping element becoming fully or partially embedded in the end of the successively forming blank during the deposition of SiO₂ particles onto the cylindrical surface of the mandrel rotating around its longitudinal axis. However, rather than becoming firmly attached to the blank, the embedded shaping element is attached in the form of a reversible connection for easy removal of the shaping element at a later time in the process.

Once the shaping element is removed, the widened shape of the inside bore hole of the blank is revealed. The geometrical shape of the widened part of the bore hole is complementary to the shape of the core area of the shaping element to the extent to which this component is embedded in the blank. The core area can become fully or partially embedded in the blank.

While it is not important whether the shaping element is made of a single part or several parts, it is essential that after deposition and removal of the component the inside bore hole of the blank is widened.

The external geometry of the core area determines the shape of the widened area of the inside bore hole at the ends of the blank. Preferably, the core area is designed to be rotationally symmetrical about the longitudinal axis of the mandrel such that the widened part of the inside bore hole is also rotationally symmetrical, thereby effectively providing for the temperature distribution during heating to be rotationally symmetrical, which simplifies the process in which the tube pipe is welded to the blank.

The shaping element becoming embedded in the successively forming blank is easier to remove, if its core area is designed to taper towards the forming blank. The core area may taper either continually or gradually, i.e. in steps.

In a very satisfactory procedure, the core area of the shaping element is shaped like a cone. Truncated cone-shaped core areas have also proven to be very suitable. Shaping elements of this type are easy to fabricate and particularly easy to remove from the blank.

The shaping element can be connected to the mandrel either in a form-fitting or friction-tight fashion. A form-fitting connection is formed for instance with a mandrel tapering off from the shaping element towards the blank to allow the shaping element to be pressed against the cone such that the shaping element and the mandrel can be pulled out of the blank at the same time. However, due to the superior ease of implementation and operating safety, friction-tight connections of shaping element and mandrel have proven more suitable.

A preferred method of forming a friction-tight connection is to insert a tension element made of a moldable material between the shaping element and the mandrel. A suitable tension element for this purpose is made from a plastic material—such as polytetrafluoroethylene (PTFE)—provided the temperature effects experienced during deposition are insufficient to cause plastic deformation of the tension element. To prevent this complication, the tension element is preferably arranged in the area of the shaping element that faces away from the blank.

In a favorable embodiment, the shaping element is designed to have an external area that protrudes from the inside bore hole of the successively forming blank. In this embodiment, the shaping element does not become fully embedded in the blank, but only partially, such that an external area axially protrudes from the core area of the shaping element. This external area is firmly connected to the core area of the shaping element and forms a preferred site for attachment of the above-mentioned tension element such that by simply grabbing hold of the external area the shaping element is easy to pull from the inside bore hole.

Moreover, to have a suitably shaped external area simplifies well-defined embedding of the shaping element in the blank. For this purpose, the part is designed to posses a ridge between its external and core areas, such that the external area protrudes over the core area in a radial direction when viewed along the mandrel's longitudinal axis. This ridge can be designed e.g. in the form of a step. One of the functions of this ridge is to prevent counterdrafts—e.g. due to turbulences in the depositing SiO₂ particles—which may lead to a direct connection forming between the blank and the shaping element, which would make it more difficult to remove the shaping element at a later time.

A shaping element, suitably suspended to be capable of sliding along the longitudinal axis of the mandrel, can be removed independent of the mandrel.

The use of a shaping element made from quartz glass has proven favorable. Quartz glass is characterized by its strong resistance to thermal and chemical influences, and its high purity, thus effectively preventing contamination of the blank.

In the following, the invention is further described by means of an embodiment and a drawing. It is shown in diagrammatic view in the single

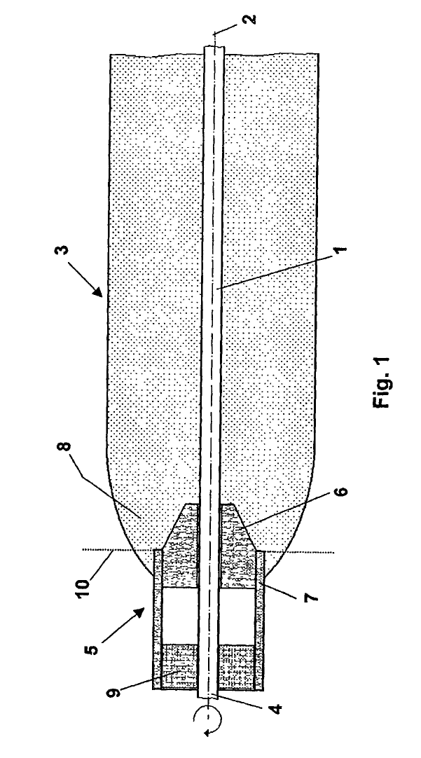

FIG. 1 a process step for manufacture of a preform for optical fibers.

FIG. 1 shows the step of the procedure, in which the inside bore hole of a porous quartz glass hollow cylinder 3 is widened by the use of a shaping cone 5. For illustrative purposes, shaping cone 5 is depicted larger than actual scale.

Layers of SiO₂ particles are deposited by the action of a flame hydrolysis burner (not shown) onto an aluminum oxide carrier tube 1 capable of rotating around its longitudinal axis leading to the formation of porous hollow cylinder 3.

The external diameter of carrier tube 1 is 8 mm. A free end 4 of carrier tube 1 extends through a rotationally symmetrical quartz glass shaping cone designated in its entirety as reference number 5. Shaping cone 5 consists of a bushing 7 from which protrudes an insert 6, shaped like a truncated cone, pointing towards hollow cylinder 3. Bushing 7 and truncated cone 6 are connected to form one unit. Truncated cone 6 contains a bore hole that extends coaxial with respect to longitudinal axis 2 and envelops carrier tube 1. The truncated cone tapers off in the direction of hollow cylinder 3 from a maximal external diameter of approx. 20 mm to a minimal external diameter of 12 mm over a stretch of 14 mm. The length of bushing 7 is approx. 80 mm and the external diameter is 27 mm. Truncated cone 6 and part of bushing 7 are embedded in front end 8 of hollow cylinder 3.

The connection between shaping cone 5 and carrier tube 1 is friction-tight. This is implemented by two semi-spherical PTFE inserts 9 located inside bushing 7 which firmly hold carrier tube 1 in place.

In the following, one embodiment of the procedure of the invention is illustrated in detail using FIG. 1 as an example.

Truncated cone 5 is fixed to carrier tube 1 in the orientation depicted in the Figure by means of PTFE semi-spheres 9. On the opposite end of carrier tube 1, a bushing-shaped quartz glass holder is installed (not shown in FIG. 1) similar to that described in DE-A1 197 51 919 referred to above. Subsequently, carrier tube 1 is clamped into a lathe and rotated around its longitudinal axis. By moving the flame hydrolysis burner back and forth along carrier tube 1, layers of SiO₂ particles are deposited onto the surface of the tube and the shaping cone (and on said bushing-shaped holder) rotating at the same speed as carrier tube 1. During this process, the ends of shaping cone 5 and the holder become embedded in successively forming hollow cylinder 3. Whereas on one of the ends a firm connection between hollow cylinder 3 and the holder is not only desired but required, the formation of a mechanical connection between hollow cylinder 3 and shaping cone 5 is to be prevented.

Upon completion of the deposition process, carrier tube 1 is pulled out of hollow cylinder 3 and shaping cone 5 is removed simultaneously. Because of the rotationally symmetrical design and cone shape of the truncated cone shaping cone 5 is easier to remove. Hollow cylinder 3 is processed with a saw along dotted line 10, if required. To forego this step, an alternative embodiment of the invention is designed to have a ridge at the position of dotted line 10 that is sufficiently high to prevent hollow cylinder 3 from growing from truncated cone 5 onto the cylindrical surface of bushing 7 during the deposition process.

Once carrier tube 1 and shaping cone 5 are removed, the inside bore hole at end 8 of hollow cylinder 3 shows a rotationally symmetrical geometry complementary to the external geometry of truncated cone 6, and successively widens as one progresses from inside to outside. Subsequently, hollow cylinder 3 is subjected to a cleaning and drying procedure using a halogen-containing atmosphere, and then sintered. During these steps, hollow cylinder 3 is held suspended in vertical direction in a treatment chamber (not shown in the Figure) using the afore-mentioned holder. After sintering, the inside bore hole has an internal diameter of approx. 3 mm; the widening of the inside bore hole at the end is maintained during the procedures at the same shrinking ratio.

Subsequently, the front end (previously end 8) of the vitrified quartz glass tube (previously hollow cylinder 3) is attached to a tube pipe. For this purpose, front end (8) of quartz glass tube (3) is heated to the softening temperature. Because the front end was widened earlier in the procedure, the softened area of the inside bore hole does not collapse at this time. Once the tube pipe is attached, the inside bore hole of the quartz glass tube can be subjected to other generally known treatment steps for the production of optical fiber preforms—such as cleaning of the internal surface by introduction of a cleaning gas.

1. A method for manufacture of a quartz glass body by deposition of SiO₂ particles on the cylinder surface area of a cylindrical mandrel rotating around its longitudinal axis under formation of an essentially cylindrical porous blank with an inside bore hole, and by removing the mandrel and sintering of the blank, characterized in that the mandrel (1) in the area of one of the ends (8) of the forming blank (3) is surrounded by a shaping element (5) rotating at the same rotation velocity as the mandrel (1), such shaping element (5) having a core area (6) facing the blank (3) which is at least partially removably embedded into the ends of the forming blank (3) and which is removed before sintering after formation of an expansion of the inside bore hole of the blank (3) adapted to the core area (6).

2. A method according to claim 1, characterized in that the core area (6) is formed rotation-symmetrically to the longitudinal axis (2) of the mandrel (1).

3. A method according to claim 1 or 2, characterized in that the core area (6) tapers in the direction of the forming blank (3).

4. A method according to claim 3, characterized in that the core area (3) is conical.

5. A method according to any one of the above claims, characterized in that the shaping element (5) is connected to the mandrel (1) frictionally engaged.

6. A method according to claim 5, characterized in that the frictional engagement is formed by inserting a tension element of a moldable material between the shaping element (5) and the mandrel (1).

7. A method according to any one of the above claims, characterized in that the shaping element (5) has an outer area (7) projecting from the forming blank (3).

8. A method according to claim 7, characterized in that a step (9) is provided between the outer area (7) and the core area (6) in such a way that the outer area (7) radially rises above the core area (6), seen in direction of the longitudinal axis of the mandrel (2).

9. A method according to any one of the claims 1 to 6, characterized in that the shaping element (5) slidably runs along the longitudinal axis of the mandrel (2).

10. A method according to any one of the above claims, characterized in that a shaping element (5) of quartz glass is inserted.
